(19) United States
(12) Patent Application Publication
(10) Pub. No.: US 2024/0386310 A1
(43) Pub. Date: Nov. 21, 2024

(54) ITERATIVE PROCESSING SYSTEM FOR SMALL AMOUNTS OF TRAINING DATA

(71) Applicant: Bank of America Corporation, Charlotte, NC (US)

(72) Inventors: Emad Noorizadeh, Plano, TX (US); Emmanuel Dibia, Dallas, TX (US); Jennifer Russell, Dallas, TX (US); Rajan Jhaveri, Plano, TX (US)

(21) Appl. No.: 18/199,073

(22) Filed: May 18, 2023

(51) Int. Cl. G06N 20/00

(52) U.S. Cl. CPC G06N 20/00

(57) ABSTRACT

A method for training a model is provided. Methods may, at a first pre-step, receive a base model. Methods may, at a first step, create a label using the base model to be applied to unlabeled data, label a first set of unlabeled data with the label and generate a first set of labeled data from the first set of unlabeled data. Methods may, at a second step, receive a second set of labeled data, separate the second set into a first group and a second group, classify the first group and the first set as training data. Methods may, at a third step, train a deep learning model using the training data, validate the deep learning model using the second group and generate a set of model parameters. Methods may, at a fourth step, save the model parameters. Methods may, at a fifth step, train the deep learning, initialized from the parameters, using the first group. Methods may, at a sixth step, replace the base model with the deep learning model and repeat steps one through six.

### FIELD OF TECHNOLOGY

Aspects of the disclosure relate to machine learning models.

### BACKGROUND OF THE DISCLOSURE

Machine learning typically requires large amounts of training data to properly train machine learning models. However, in certain complex or detailed circumstances, only a small amount of training data may be available. As such, it may be difficult to create and tune accurate machine learning models for complex or detailed circumstances.

In certain environments, autoencoders, which are unsupervised neural networks that receive large amounts of unlabeled data elements to identify a reduced number of features within a plurality of data points, may be used. However, in such complex and detailed circumstances, autoencoders may not be available at least because autoencoders may require large amounts of unlabeled data elements, which may not be available in such complex or detailed circumstances. Additionally, autoencoders may not provide a feedback loop which is capable of fine tuning a model.

As such, it may be desirable to provide an iterative processing system that may be able to utilize a small amount of training data to accurately generate a model. Specifically, because an iterative processing system may automatically provide feedback to itself, such an iterative processing system may augment the data to appropriately train a model.

### SUMMARY OF THE DISCLOSURE

Apparatus and methods for training models may be provided. The training models may be used to identify complaints within calls and/or any other suitable machine-learning process. An iterative process may be used to augment the data in order to appropriately train a machine learning model that identifies complaints.

There may be approximately seven thousand training data points used to train a complaint machine learning process. As such, because data is limited to train a model, an iterative solution may be used tune the model such that a fixed supervision model may produce over a threshold of performance metrics.

The iterative process may include the following steps:

Step 0: Receiving a base model.

Step 1: Creating a label using the base model.

Step 2: Using 70% of a received labeled dataset with the labeled data produced in step 1.

Step 3: Training a deep learning model using data produced from step 2, Validating the deep learning model using remaining 30% of the received labeled dataset.

Step 4: Saving the model parameters from the model trained in step 3.

Step 5: Training a deep learning model, initialized from previous model weights, using the 70% from step 2.

Step 6: Replacing the base model with output from Step 5 and repeating training process until convergence of the model.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIGS. 2A, 2B and 2C shows another illustrative diagram in accordance with principles of the disclosure;

FIG. 3 shows still another illustrative diagram in accordance with principles of the disclosure; and

FIG. 4 shows yet another illustrative diagram in accordance with principles of the disclosure.

### DETAILED DESCRIPTION OF THE DISCLOSURE

Apparatus and methods for training a model may be provided. Apparatus and methods may include a system for training a machine-learning model. The system may include a hardware processor. The hardware processor may operate in tandem with a hardware memory. The hardware processor may be operable to execute a plurality of steps to train the machine-learning model.

A first step may include generating a base machine-learning model. The base machine-learning model may include one or more logistic regression components/models and one or more deep learning components/models. The base machine-learning model may produce results that have less than a threshold percentage of performance metrics accuracy. As such, the base model may produce insufficient results for a presented machine-learning scenario. As such, the base model may be tuned and trained, as shown in the following steps, in order to raise the performance metrics accuracy above a predetermined threshold of performance metrics accuracy.

A second step may include generating a label at the base model. The label may be operable to characterize unlabeled data. The second step may also include labeling a first set of unlabeled data with the label to generate a first set of labeled data. The output of the second step may be a first set of labeled data.

A third step may include receiving a second set of labeled data. The third step may also include separating the second set of labeled data into a first group and a second group.

The first group may include 70% of the second set of labeled data. The first group may include at least 70% of the second set of labeled data. The first group may include at most 70% of the second set of labeled data. The first group may include any other suitable percentage of the second set of labeled data.

The second group may include 30% of the second set of labeled data. The second group may include at least 30% of the second set of labeled data. The second group may include at most 30% of the second set of labeled data. The second group may include any other suitable percentage of the second set of labeled data. It should be noted that, in certain embodiments, the percentage of the first group in addition to the percentage of the second group may add up to approximately one hundred percent.

The third step may also include classifying the first set of labeled data and the first group as training data. It should be noted that any other suitable combination of data groups may be used as training data.

A fourth step may include training a deep learning model using the training data. The fourth step may also include validating the deep learning model using the second group. Following the validation, the fourth step may also include generating a set of model parameters and a set of associated model weights at the deep learning model.

A fifth step may include saving the set of model parameters and/or the set of associated model weights.

A sixth step may include training the deep learning model using the first group. The deep learning model may be initialized from the model parameters and the set of associated model weights. In some embodiments, 80% of the first group may be used as training data and 20% of the first group may be used as testing data.

A seventh step may include replacing the base model with the deep learning model. The seventh step may include repeating steps two through seven until a model convergence of the trained deep learning model is obtained.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

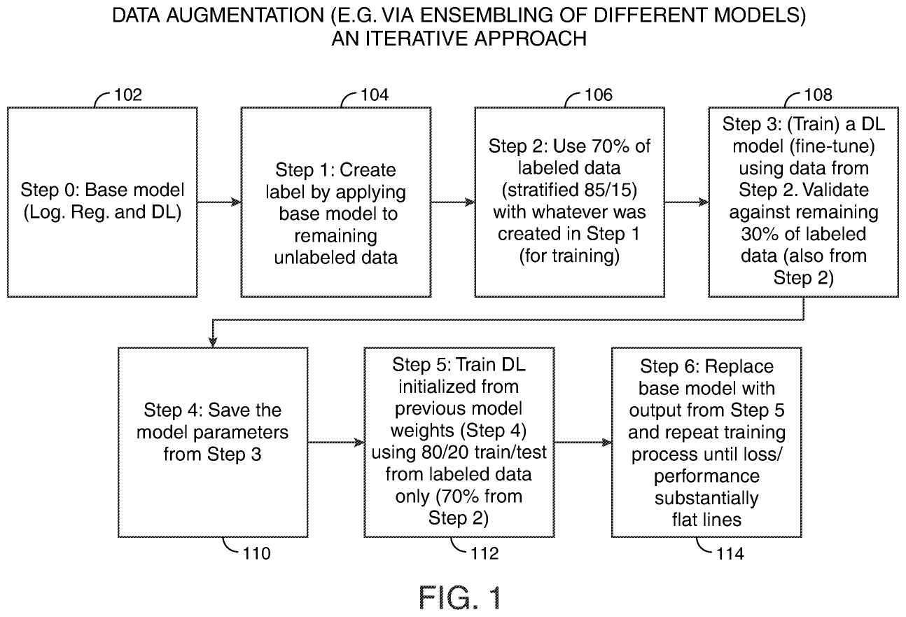

FIG. 1 shows an illustrative diagram. The illustrative diagram shows an iterative approach to data augmentation. In order to train a deep learning model using relatively small amounts of training data (e.g., less than ten thousand data points), a system may use an iterative approach to augment the available training data. The system may ensemble a plurality of different models to facilitate the data augmentation.

Step 0, shown at 102, may include a base model. The base model may be a logistic regression model, a deep learning (“DL”) model and or a combination of one or more logistic regression models and one or more DL models.

A logistic regression model may be understood to mean a data analysis model that uses mathematics to find the relationships between two data factors. The model may then use the identified relationship to predict the value of one of those factors based on the other. The prediction may have a finite number of outcomes, like yes or no.

A deep learning model may be understood to mean a model that uses artificial intelligence (AI) and neural networks to teach computers to process data in a way that is inspired by the human brain. Deep learning models may recognize complex patterns in pictures, text, sounds, and other data to produce accurate insights and predictions.

Step 1, shown at 104, may show creating a label by applying the base model on the remaining unlabeled data. As such, the base model may be able to generate one or more labels based on the small amount of available labeled training data. The generated one or more labels may be used to label available unlabeled training data. The system may label the available unlabeled training data.

A labeled training data may be received. The labeled training data may correspond to a specific entity or specific sub-entity. The labeled training data may be particular to a category.

Step 2, shown at 106, shows using the following as training data: 70% of specific entity's labeled training data set and the labeled training data generated at step 1.

The 70% of the labeled training data may be stratified at a ratio of 85 to 15. Stratifying a data set may include splitting a data set so that each split is similar with respect to something. Stratifying may be used to ensure that the train and test sets have approximately the same percentage of samples of each target class as the complete set.

It should be noted that if the dataset has a large amount of each class, stratifying may produce a similar result to random sampling. However, if one class is not represented significantly in the data set (which may be the case in a dataset that attempts to oversample a minority class), then stratifying may produce a different target class distribution in the train and test sets than what random sampling may produce.

Stratifying a dataset may also be designed to equally distribute some features in the train and test sets. For example, if each sample represents one geometric shape, and one feature is height, it may be useful to have the same height distribution in both the train and test set.

Step 3, shown at 108, shows training and fine-tuning a deep learning model using the training data identified in step 2. Step 3 also includes validating the deep learning model against the 30% of the specific entity's labeled training data set. It should be noted that validating may include using the deep learning model to label the 30% of the specific entity's labeled training data set. The validating may include comparing the label produced by the deep learning model to the label previously provided. The validating may include determining whether the deep learning model accurately labels the 30% of the labeled training dataset. Accurately labeling the 30% of the labeled training dataset may be defined as when the labels generated by the deep learning model match the received labels at greater than a predetermined threshold. The predetermined threshold may be 60%, 70%, 80%, 90%, 100% or any other suitable threshold.

Step 4, shown at 110, shows saving the model parameters from step 3. It should be understood that when the deep learning model is trained and fine-tuned in step 3, the model parameters (and associated weights) may be updated. As such, those parameters and weights may be stored.

Step 5, shown at 112, shows training the deep learning model. The deep learning model may be initialized using the model parameters (and associated weights) stored at step 4. The deep learning model may be initialized from the 70% of the labeled training data. The 70% of the labeled training data may be used to train the deep learning model at an 80 to 20 train to test ratio. Using the 70% of the labeled training data at an 80 to 20 train to test ratio may be understood as follows: 1. the 70% of the labeled training data may be split into a group of 80% and a group of 20% 2. the 80% may be used to train the deep learning model and 3. the 20% may be used to test the deep learning model once the deep learning model has been trained with the 80%. Testing the deep learning model with the 20% may include labeling each data point with a new label, comparing the new label to a previous label and identifying whether greater than a predetermined threshold of new labels match the previous labels. The predetermined threshold may be 60%, 70%, 80%, 90%, 100% or any other suitable threshold. The output of step 5 may be a tuned deep learning model.

Step 6, shown at 114, shows replacing the base model (in step 0) with the output of step 5 and repeating the training process (including steps 0 through 6) until loss/performance substantially flat lines. Loss/performance substantially flat lines may be understood to mean model convergence.

An iterative process is said to converge (or obtain model convergence) when, as the iterations proceed, the output gets closer and closer to some specific value or range of values. The value or range of values may be referred to as a threshold range. Additionally, no matter how small an error range is selected, if enough iterations are processed, the function may eventually stay within that error range around the final value.

In some circumstances, a model will not converge, having an output that always varies by some amount. A model may even diverge, where the model's output will undergo larger and larger value swings, never approaching a convergence. More specifically, no matter how long the iterations continue, the function value will never settle down within a range of any final value.

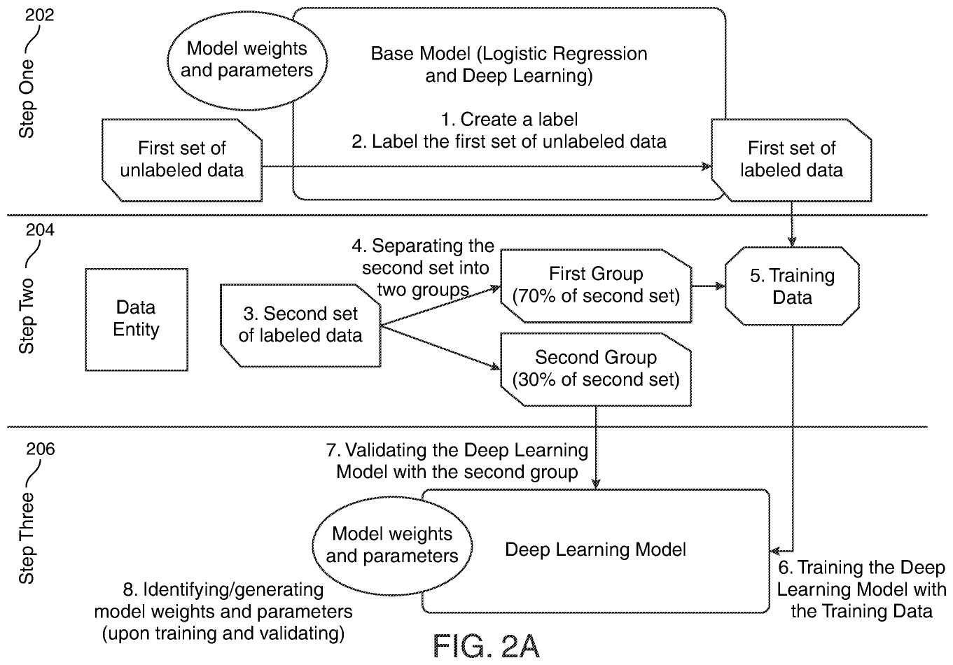

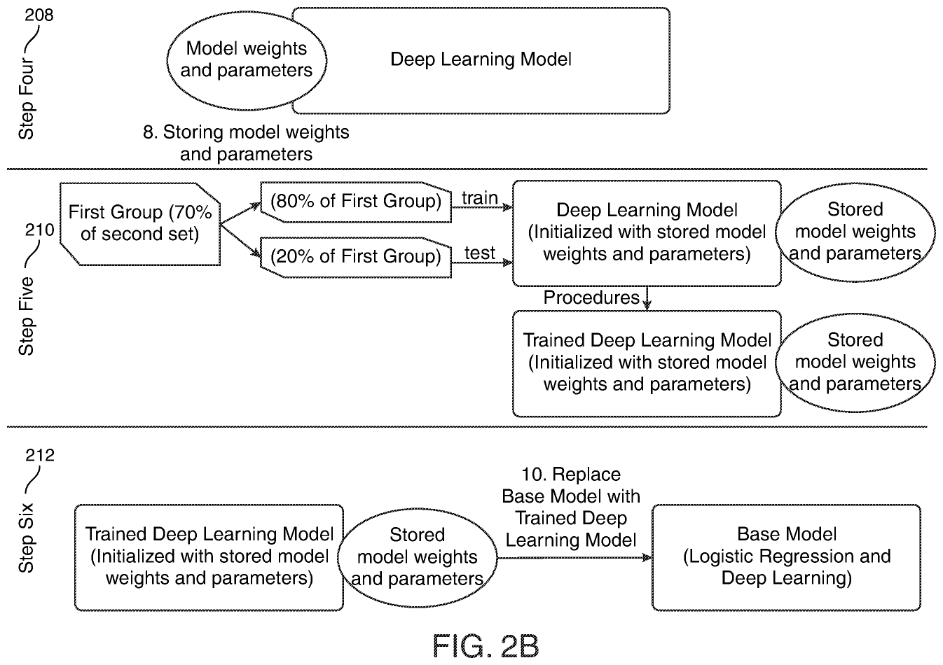

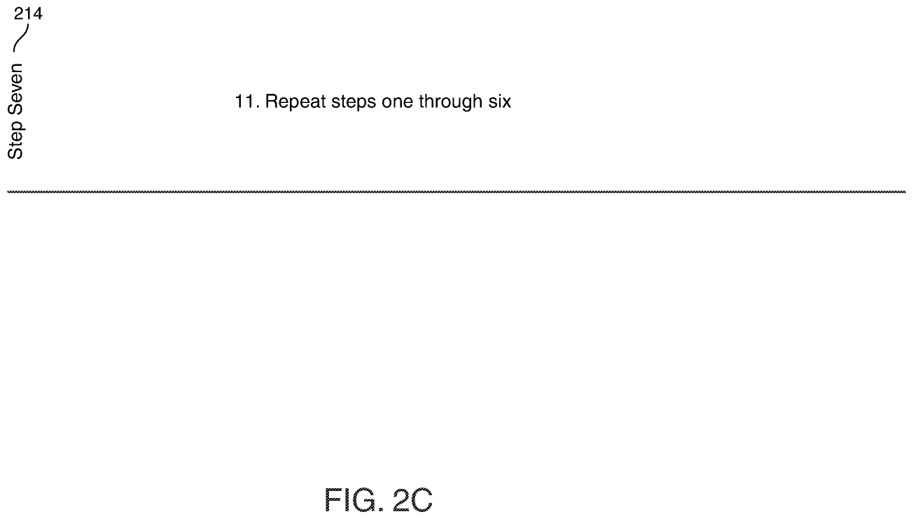

FIGS. 2A, 2B and 2C show an illustrative diagram. The illustrative diagram shows steps one through seven at 202 through 214. It should be noted that the numbering of the steps may be shown differently in various embodiments.

Step one, shown at 202, shows a base model with model weight and params (parameters). The base model may create a label. The base model may receive a first of unlabeled data. The base model may label the first set of unlabeled data thereby producing a first set of labeled data.

Step two, shown at 204, shows a data entity. The data entity may transmit a second set of labeled data. The data entity may transmit the second set of labeled data to the base model and/or to the system operating the iterative process. The second set of labeled data may be separated into two groups: a first group and a second group. The first group may include 70% of the second set. The second group may include 30% of the second set. The first group in addition to the first set of labeled data may be identified as the ‘training data’.

Step three, shown at 206, shows a deep learning model with model weights and params. The deep learning model may be trained with the data from step two. Upon training, the deep learning model may be validated with the second group (the 30% of the second set). Upon training and validating, a set of model weights and params may be identified and/or generated.

Step four, shown at 208, shows the deep learning model with model weights and params. It should be noted that the model weights and params may be updated and/or changed during the training process. At step four, the model weights and params may be stored.

Step five, shown at 210, shows training the deep learning model with the first group using an 80 to 20 train to test ratio. The first group, which includes 70% of the second set, may be divided into a group of 80% of the 70% of the second set and a group of 20% of the 70% of the second set. The group of 80% may be identified as training data. The group of 20% may be identified testing data. The group of 80% may be used to train the deep learning model that has been initialized with the model weights and params. Upon training, a trained deep learning model may be produced. The group of 20% may be used to test the trained deep learning model.

Step six, shown at 212, shows replacing the base model with the trained deep learning model (which may be the output of step five).

Step seven, shown at 214, shows repeating steps one through six. The steps may be repeated until the model converges into to a threshold error range.

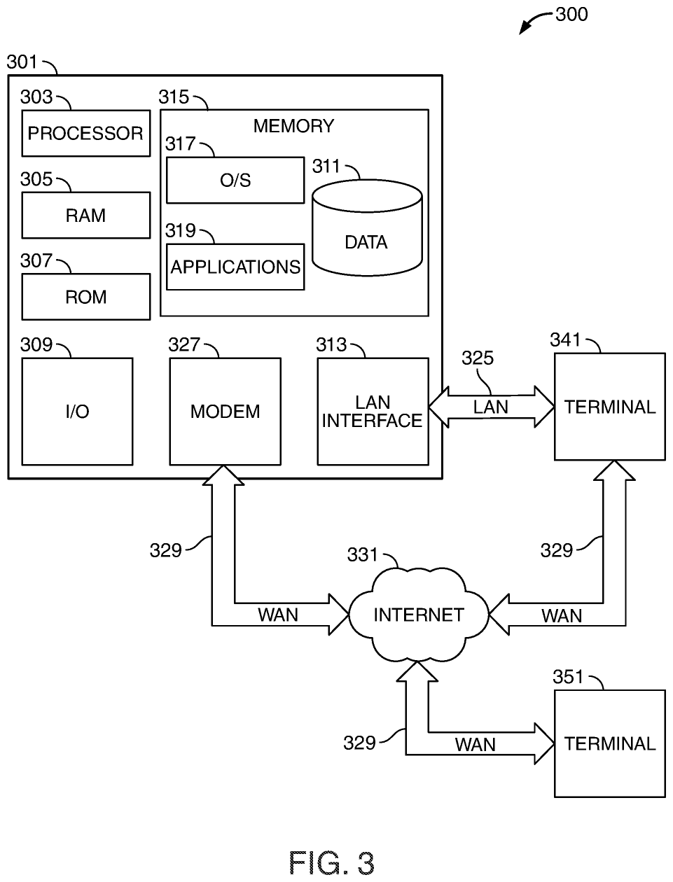

FIG. 3 shows an illustrative block diagram of system 300 that includes computer 301. Computer 301 may alternatively be referred to herein as a “server” or a “computing device.” Computer 301 may be a workstation, desktop, laptop, tablet, smart phone, or any other suitable computing device. Elements of system 300, including computer 301, may be used to implement various aspects of the systems and methods disclosed herein.

Computer 301 may have a processor 303 for controlling the operation of the device and its associated components, and may include RAM 305, ROM 307, input/output module 309, and a memory 315. The processor 303 may also execute all software running on the computer—e.g., the operating system and/or voice recognition software. Other components commonly used for computers, such as EEPROM or Flash memory or any other suitable components, may also be part of the computer 301.

The memory 315 may comprise any suitable permanent storage technology—e.g., a hard drive. The memory 315 may store software including the operating system 317 and application(s) 319 along with any data 311 needed for the operation of the system 300. Memory 315 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 301 may execute the instructions embodied by the software to perform various functions.

Input/output (“I/O”) module may include connectivity to a microphone, keyboard, touch screen, mouse, and/or stylus through which a user of computer 301 may provide input. The input may include input relating to cursor movement. The input may relate to transaction pattern tracking and prediction. The input/output module may also include one or more speakers for providing audio output and a video display device for providing textual, audio, audiovisual, and/or graphical output. The input and output may be related to computer application functionality. The input and output may be related to transaction pattern tracking and prediction.

System 300 may be connected to other systems via a local area network (LAN) interface 313.

System 300 may operate in a networked environment supporting connections to one or more remote computers, such as terminals 341 and 351. Terminals 341 and 351 may be personal computers or servers that include many or all of the elements described above relative to system 300. The network connections depicted in FIG. 3 include a local area network (LAN) 325 and a wide area network (WAN) 329, but may also include other networks. When used in a LAN networking environment, computer 301 is connected to LAN 325 through a LAN interface or adapter 313. When used in a WAN networking environment, computer 301 may include a modem 327 or other means for establishing communications over WAN 329, such as Internet 331.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 319, which may be used by computer 301, may include computer executable instructions for invoking user functionality related to communication, such as e-mail, Short Message Service (SMS), and voice input and speech recognition applications. Application program(s) 319 (which may be alternatively referred to herein as “plugins,” “applications,” or “apps”) may include computer executable instructions for invoking user functionality related to performing various tasks. The various tasks may be related to transaction pattern tracking and prediction.

Computer 301 and/or terminals 341 and 351 may also be devices including various other components, such as a battery, speaker, and/or antennas (not shown).

Terminal 351 and/or terminal 341 may be portable devices such as a laptop, cell phone, Blackberry™, tablet, smartphone, or any other suitable device for receiving, storing, transmitting and/or displaying relevant information. Terminals 351 and/or terminal 341 may be other devices. These devices may be identical to system 300 or different. The differences may be related to hardware components and/or software components.

Any information described above in connection with database 311, and any other suitable information, may be stored in memory 315. One or more of applications 319 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

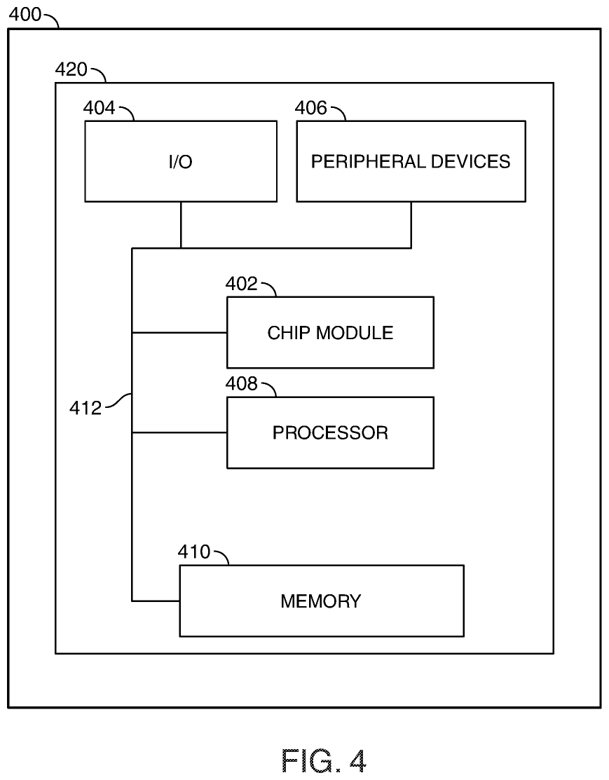

FIG. 4 shows illustrative apparatus 400 that may be configured in accordance with the principles of the disclosure. Apparatus 400 may be a computing machine. Apparatus 400 may include one or more features of the apparatus shown in FIG. 3. Apparatus 400 may include chip module 402, which may include one or more integrated circuits, and which may include logic configured to perform any other suitable logical operations.

Apparatus 400 may include one or more of the following components: I/O circuitry 404, which may include a transmitter device and a receiver device and may interface with fiber optic cable, coaxial cable, telephone lines, wireless devices, PHY layer hardware, a keypad/display control device or any other suitable media or devices; peripheral devices 406, which may include counter timers, real-time timers, power-on reset generators or any other suitable peripheral devices; logical processing device 408, which may compute data structural information and structural parameters of the data; and machine-readable memory 410.

Machine-readable memory 410 may be configured to store in machine-readable data structures: machine executable instructions (which may be alternatively referred to herein as “computer instructions” or “computer code”), applications, signals, and/or any other suitable information or data structures.

Components 402, 404, 406, 408 and 410 may be coupled together by a system bus or other interconnections 412 and may be present on one or more circuit boards such as 420. In some embodiments, the components may be integrated into a single chip. The chip may be silicon-based.

Thus, systems and methods for an iterative processing system for relatively small amounts of training data are provided. Persons skilled in the art will appreciate that the present invention can be practiced by other than the described embodiments, which are presented for purposes of illustration rather than of limitation. The present invention is limited only by the claims that follow.

What is claimed is:

1. A method for training a model, the method comprising:
at a pre-first step:
receiving a base model;
at a first step:
creating a label using the base model to be applied to unlabeled data;
labeling a first set of unlabeled data with the label; and
generating a first set of labeled data from the first set of unlabeled data;
at a second step:
receiving a second set of labeled data from a data group;
separating the second set of labeled data into a first group comprising 70% of the second set of labeled data and a second group comprising 30% of the second set of labeled data; and
classifying the first set of labeled data and the first group of the second set of labeled data as training data;
at a third step:
training a deep learning model using the training data;
validating the deep learning model using the second group of the second set of labeled data; and
following the validating, generating a set of model parameters and a set of associated model weights at the deep learning model;
at a fourth step:
saving the set of model parameters and the set of associated model weights;
at a fifth step:
training the deep learning model, initialized from the set of model parameters and the set of model weights, using the first group of the second set of labeled data;
at a sixth step:
replacing the base model with a trained deep learning model obtained at step five;
repeating steps one through six until model convergence of the trained deep learning model is obtained.

2. The method of claim 1 wherein the base model comprises a logistic regression component.

3. The method of claim 1 wherein the base model comprises a deep learning component.

4. The method of claim 1 wherein the base model comprises one or more logistic regression components and one or more deep learning components.

5. The method of claim 1 wherein the first set of labeled data and the first group of the second set of labeled data are stratified at a ratio of 85 to 15.

6. The method of claim 1 wherein the base model comprises less than a threshold percentage of performance metrics accuracy.

7. The method of claim 1 wherein said training the deep learning model, using the first group of the second set of labeled data, comprising using 80% of the first group of the second set of labeled data as training data and 20% of the first group of the second set of labeled data as testing data.

8. A system for training a machine-learning model, the system comprising:
a hardware processor operating in tandem with a hardware memory, the hardware processor operable to execute a plurality of steps to train the machine-learning model, the plurality of steps comprising:
a first step operable to generate a base machine-learning model;
a second step operable to:
generate a label at the base model, the label operable to characterize unlabeled data; and
label a first set of unlabeled data with the label to generate a first set of labeled data;
a third step operable to:
receive a second set of labeled data;
separate the second set of labeled data into a first group and a second group;
classify the first set of labeled data and the first group as training data;
a fourth step operable to:
train a deep learning model using the training data;
validate the deep learning model using the second group; and
following the validation, generate a set of model parameters and a set of associated model weights at the deep learning model;
a fifth step operable to:
save the set of model parameters and the set of associated model weights;
a sixth step operable to:
train the deep learning model using the first group, said deep learning model initialized from the model parameters and the set of associated model weights;
a seventh step operable to:
replace the base model with the deep learning model; and
repeat steps two through seven until a model convergence of the trained deep learning model is obtained.

9. The system of claim 8 wherein the first group comprises at least 70% of the second set of labeled data, and the second group comprises at most 30% of the second set of labeled data.

10. The system of claim 8 wherein the first group comprises at most 70% of the second set of labeled data, and the second group comprises at least 30% of the second set of labeled data.

11. The system of claim 8 wherein the using the first group to train the deep learning model at the sixth step further comprises using 80% of the first group as training data and 20% of the first group as testing data.

12. The system of claim 8 wherein the base machine-learning model comprises a logistic regression component.

13. The system of claim 8 wherein the base machine-learning model comprise a deep learning component.

14. The system of claim 8 wherein the base model comprises less than a threshold percentage of performance metrics accuracy.

15. The system of claim 8 wherein the training data of step two is stratified at a ratio of 85 to 15.

16. A method for training a model, the method comprising:
at a pre-first step:
receiving a base model;
at a first step:
creating a label using the base model to be applied to unlabeled data;
labeling a first set of unlabeled data with the label; and
generating a first set of labeled data from the first set of unlabeled data;
at a second step:
receiving a second set of labeled data from a data group;
separating the second set of labeled data into a first group comprising at least 70% of the second set of labeled data and a second group comprising at most 30% of the second set of labeled data; and
classifying the first set of labeled data and the first group of the second set of labeled data as training data;
at a third step:
training a deep learning model using the training data;
validating the deep learning model using the second group of the second set of labeled data; and
following the validating, generating a set of model parameters and a set of associated model weights at the deep learning model;
at a fourth step:
saving the set of model parameters and the set of associated model weights;
at a fifth step:
training the deep learning model, initialized from the set of model parameters and the set of model weights, using the first group of the second set of labeled data;
at a sixth step:
replacing the base model with a trained deep learning model obtained at step five;
repeating steps one through six until model convergence of the trained deep learning model is obtained.

17. The method of claim 16 wherein the first set of labeled data and the first group of the second set of labeled data are stratified at a ratio of 85 to 15.

18. The method of claim 16 wherein the base model comprises less than a threshold percentage of performance metrics accuracy.

19. The method of claim 16 wherein said training the deep learning model, using the first group of the second set of labeled data, comprising using 80% of the first group of the second set of labeled data as training data and 20% of the first group of the second set of labeled data as testing data.

20. The method of claim 16 wherein the base model comprises one or more logistic regression components and one or more deep learning components.
